(19) United States
(12) Patent Application Publication
(10) Pub. No.: US 2009/0143509 A1
(43) Pub. Date: Jun. 4, 2009

(54) INKJET INK

(75) Inventors: Yoshiaki Shikata, Tomi-city (JP); Nami Hatakeyama, Tomi-city (JP); Isao Tabayashi, Tomi-city (JP)

Correspondence Address: DITTHAVONG MORI & STEINER, P.C., 918 Prince St., Alexandria, VA, 22314, US

(73) Assignee: MIMAKI ENGINEERING CO., LTD., Tomi-city (JP)

(21) Appl. No.: 12/240,453

(22) Filed: Sep. 29, 2008

(30) Foreign Application Priority Data
Dec. 3, 2007 (JP) 2007-311944

(51) Int. Cl. C08K 5/1515; C08L 31/04; C08K 5/57

(52) U.S. Cl. 524/114; 524/563; 524/178

(57) ABSTRACT

An inkjet ink is provided containing a colorant and using vinyl chloride-vinyl acetate copolymer resin, and characterized in that a stabilizer for preventing the vinyl chloride-vinyl acetate copolymer resin in the inkjet ink from being degraded with age is added. An inkjet ink is provided using VCVAC resin which is capable of preventing the VCVAC resin from being degraded and thus preventing increase in viscosity thereof.

### CROSS-REFERENCE TO RELATED APPLICATION

The present application claims priority to Japanese Patent Application No. 2007-311944, filed on Dec. 3, 2007, the entire contents of which are herein incorporated by reference.

### BACKGROUND OF THE INVENTION

1. Field of the Invention

The present invention relates to an ink for inkjet printing.

2. Discussion of the Background

Various inkjet recording methods have been proposed, for example, a method of utilizing electrostatic attraction to eject ink droplets (so-called electric-field control method), a method of utilizing vibration pressure of a piezoelectric element to eject ink droplets (so-called drop-on-demand method (pressure pulse method)), and a method of utilizing pressure which is generated by forming and developing air bubbles with high temperature (so-called thermal inkjet method). These methods allow extremely high-definition images to be obtained.

These inkjet recording methods typically use water-based inks using water as the main solvent and oil-based inks using organic solvent as the main solvent. Generally, images printed using a water-based ink have poor water resistance, while oil-based ink can provide images having excellent water resistance.

Various inkjet inks have been developed and used. For example, there is known an inkjet ink using vinyl chloride-vinyl acetate copolymer resin (hereinafter, referred to as “VCVAC resin”) (e.g., WO2004/007626). However, there is a need for improvement in characteristics of inkjet ink using VCVAC resin.

### SUMMARY OF THE INVENTION

The present invention advantageously provides an inkjet ink containing a colorant and using vinyl chloride-vinyl acetate copolymer resin, wherein a stabilizer for preventing the vinyl chloride-vinyl acetate copolymer resin in the inkjet ink from being degraded with age is added.

The present invention further advantageously provides that the stabilizer is an organotin stabilizer.

The present invention also advantageously provides that the stabilizer is a combination of an organotin stabilizer and an epoxy-modified vegetable oil plasticizer.

The present invention additionally advantageously provides that the inkjet ink contains a solvent of one or a mixture of two of solvents represented by the following general formulas as a solvent for dissolving the vinyl chloride-vinyl acetate copolymer resin

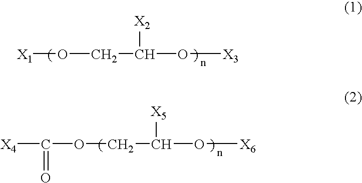

wherein in the above formulas (1), (2), each of X₁ through X₆ is H or an alkyl group.

### DETAILED DESCRIPTION OF EXEMPLARY EMBODIMENTS OF THE INVENTION

Embodiments of the present invention will be described hereinafter.

Inventors of the present invention found that inkjet inks using VCVAC resin have a problem. That is, as the VCVAC resin in the ink is degraded with age, the viscosity thereof is increased (i.e., the ink is thickened) so as to cause a decrease in ejection stability of an inkjet printer and a decrease in performance such as abrasion quality, and drying property so that it is difficult to maintain the stable performance of inkjet ink.

As a result of development of ink capable of maintaining the stable performance of for inkjet ink using VCVAC resin, the inventors of the present invention found that by adding “a stabilizer capable of preventing the VCVAC resin in the inkjet ink from being degraded” (solving means), the VCVAC resin can be prevented from being degraded with age, thereby stably maintaining the performance of the inkjet ink (e.g., ejection stability, abrasion quality, and drying properties) and thus resulted in the present invention.

In a first arrangement, an inkjet ink is provided that contains a colorant and uses vinyl chloride-vinyl acetate copolymer resin, wherein a stabilizer for preventing the vinyl chloride-vinyl acetate copolymer resin in the inkjet ink from being degraded with age is added.

In a second arrangement, the stabilizer is an organotin stabilizer.

In a third arrangement, the stabilizer is a combination of an organotin stabilizer and an epoxy-modified vegetable oil plasticizer.

In a fourth arrangement, the inkjet ink contains a solvent of one or a mixture of two of solvents represented by the following general formulas as a solvent for dissolving the vinyl chloride-vinyl acetate copolymer resin

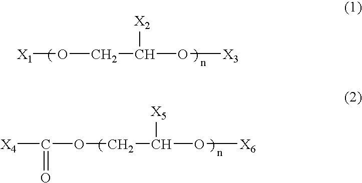

in the above formulas (1), (2), each of X₁ through X₆ is H or an alkyl group.

According to an embodiment of the present invention, in an inkjet ink using a VCVAC resin, the VCVAC resin can be prevented from being degraded by adding a stabilizer capable of preventing the VCVAC resin in the inkjet ink from being degraded with age. This allows the performance of the inkjet ink (e.g., ejection stability, abrasion quality, and drying properties) to be stably maintained.

Thus, in the first arrangement, an inkjet ink is provided that contains a colorant and uses a vinyl chloride-vinyl acetate copolymer resin and is characterized in that a stabilizer for preventing the vinyl chloride-vinyl acetate copolymer resin from being degraded with age is added.

In the inkjet ink using vinyl chloride-vinyl acetate copolymer resin (hereinafter, referred to as “VCVAC resin”), the VCVAC resin can be prevented from being degraded by adding a stabilizer for preventing the VCVAC resin from being degraded with age (hereinafter, referred to as a “predetermined stabilizer”). The prevention of degradation of the VCVAC resin prevents increase in viscosity, thus preventing decrease in ejection stability of an inkjet printer. In addition, the prevention of degradation of the VCVAC resin prevents decrease in abrasion quality and drying property. Therefore, it is possible to stably maintain the performance of inkjet ink (e.g., ejection stability, abrasion quality, and drying property).

In an embodiment of the present invention, if the VCVAC resin cannot be prevented from being degraded regardless of the kind of the stabilizer and regardless of whether the stabilizer is added or not, it is impossible to stably maintain the performance of inkjet ink (e.g., ejection stability, abrasion quality, and drying property).

Therefore, it is preferable that the aforementioned predetermined stabilizer and its additive amount are such a stabilizer and an additive amount that the function of preventing the degradation of the VCVAC resin and the function of thereby preventing the increase in viscosity can be substantially recognized. For example, the stabilizer and its additive amount having the aforementioned effective functions are preferably a stabilizer and its additive amount capable of controlling the increase in viscosity with age (viscosity changing rate) to be 10% or less.

It is preferable that the stabilizer is an organotin stabilizer.

This is because organotin stabilizers excel in function of preventing the degradation of the VCVAC resin and function of thereby preventing the increase in viscosity.

Examples of the organotin stabilizer include a butyltin stabilizer, an octyltin stabilizer, a methyltin stabilizer, a laurate stabilizer, a maleate stabilizer, and a mercapto stabilizer.

It is also preferable that the stabilizer is a combination of an organotin stabilizer and an epoxy-modified vegetable oil plasticizer.

The stabilizer, i.e. a combination of an organotin stabilizer and an epoxy-modified vegetable oil plasticizer, very much excels in the function of preventing the degradation of the VCVAC resin and the function of thereby preventing the increase in viscosity.

Examples of the stabilizer as a combination of an organotin stabilizer and an epoxy-modified vegetable oil plasticizer include ADK CIZER O-series available from ADEKA Corporation, #8102 and #8831 available from Nitto Kasei Co., Ltd., ADK STAB 465E and ADK STAB OT-1 available from ADEKA Corporation, and EMBILIZER available from Tokyo Fine Chemical CO., LTD.

The ink can be suitably adapted to an inkjet ink as a solvent/oil-based ink containing a solvent and vinyl chloride-vinyl acetate copolymer resin. For example, the ink can be suitably adapted to an inkjet ink as a solvent/oil-based ink containing vinyl chloride-vinyl acetate copolymer resin as a binder resin.

Examples of the vinyl chloride-vinyl acetate copolymer resin include VYNS-3, VYHH, VYHD, VMCH, VMCC, VMCA, VERR-40, VAGH, VAGD, VAGF, and VROH manufactured by The Dow Chemical Company, SOLBIN C, SOLBIN CL, SOLBIN CH, SOLBIN CN, SOLBIN C5, SOLBIN C5R, SOLBIN M, SOLBIN ML, SOLBIN TA5R, SOLBIN TAO, SOLBIN MK6, SOLBIN TA2 and so on manufactured by Nisshin Chemical Industry, Co., Ltd.

It is preferable to use a solvent of one or a mixture of two of solvents represented by the following general formulas as the solvent for dissolving the aforementioned vinyl chloride-vinyl acetate copolymer resin.

This is because these have good properties with less erosion of the head member and erosion of media as compared to the case using another solvent.

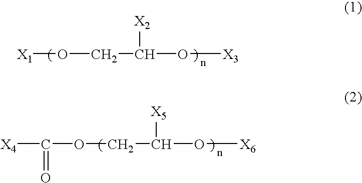

In the above formulas (1), (2), each of X₁ through X₆ is H or an alkyl group.

Solvents represented by the above formula (1) include polyoxyethylene alkyl ethers such as diethylene glycol monohexyl ether (e.g., trade name: Hexyldiglycol (HeDG) available from Nippon Nyukazai Co., Ltd.), diethylene glycol hexylether, dipropylene glycol dimethyl ether (e.g., trade name: dimethyl propylene glycol (DMFDG) available from Nippon Nyukazai Co., Ltd.), diethylene glycol diethyl ether (e.g., trade name: diethyl digrycol (DEDG) available from Nippon Nyukazai Co., Ltd.).

Solvents represented by the above formula (2) include polyoxyethylene alkyl ether acetates such as propylene glycol monomethyl ether acetate (abbr. PMA), dipropylene glycol (mono)methyl ether acetate (dipropylene glycol monomethyl ether monomethyl acetate) (abbr. DPMA), and ethylene glycol monobuthyl ether acetate (abbr. BMGAC).

The oil-based inkjet ink according to an embodiment of the present invention preferably contains a colorant and a binder resin which are suitably dissolved or dispersed in the solvent together with the dispersant (e.g., see international publication no. WO2004/007626).

As a method of producing the oil-based inkjet ink, a solvent or a mixed solvent is prepared as the solvent of ink composition. A pigment and a dispersant are added into a part of the solvent and are mixed and dispersed by a ball mill, a bead mill, an ultrasonic mill, or a jet mill so as to obtain a pigment dispersed liquid. The residual of the aforementioned solvent, a binder resin, and other additives are added into the obtained pigment dispersed liquid while being stirred, thereby producing the ink composition.

In the aforementioned ink composition, the binder resin is preferably vinyl chloride-vinyl acetate copolymer resin. Another binder resin of rosin series, acrylic series, polyester series, or urethane series may be used together with the vinyl chloride-vinyl acetate copolymer resin.

A stabilizer such as an oxidation inhibitor and an ultraviolet absorber, a surface acting agent may be added into the aforementioned ink composition. As the oxidation inhibitor, BHA (2,3-butlyl-4-oxyanisol), BHT (2,6-di-t-butyl-p-cresol) may be employed and its amount is of from 0.01% to 3.0% by weight relative to the oil-based ink composition. As the ultraviolet absorber, a benzophenone compound or a benzotriazole compound may be employed and its amount is of from 0.01% to 0.5% by weight relative to the oil-based ink composition.

In addition, as the surface acting agent, any of anionic, cationic, and amphoteric or nonionic surface acting agents may be employed and its amount is of from 0.5% to 4.0% by weight relative to the oil-based ink composition.

### EXAMPLES

Hereinafter, embodiments of the present invention will be specifically described with reference to examples. However, the present invention is not limited these examples.

### Preparation of Resin Solution I

The following mixed solvent was used as the solvent:
(i) Propylene glycol monomethyl ether acetate (abbr. PMA): 45 parts by weight;
(ii) Diethylene glycol monohexyl ether (trade name: Hexyldiglycol (HeDG) available from Nippon Nyukazai Co., Ltd.): 10 parts by weight; and
(iii) Ethylene glycol monobuthyl ether acetate (BMGAC): 45 parts by weight.

Vinyl chloride-vinyl acetate copolymer resin was added into the mixed solvent obtained by mixing the aforementioned three solvents while being stirred. The resin was dissolved by a stirrer (Three-one motor available from Shinto Scientific Co., Ltd.) while being warmed at about 50° C. for 1 hour by a water bath so as to obtain Resin Solutions I with a resin concentration of 5 wt %. As the vinyl chloride-vinyl acetate copolymer resin, SOLBIN C5R available from Nisshin Chemical Industry, Co., Ltd. or VYHD available from Dow Chemical Company was used.

### Preparation of Resin Solution II

The following additive: as a stabilizer (1) a stabilizer of epoxy-modified vegetable oil: O-130P available from ADEKA Corporation, (2) an organotin stabilizer: #8102, #8105, #8832 available from Nitto Kasei Co., Ltd., or (3) a mixture of the aforementioned (1) and (2) was added into the Resin Solutions I and stirred so as to obtain Resin Solutions II as shown in Table 1, Table 2. Similarly, the Resin Solution I in which no stabilizer was added as shown in Table 1 was used as comparative examples.

For observing the adverse effect due to moisture absorption, test solutions were made by adding water 2 wt % to the Resin Solution II in which the additive was added and the Resin Solution I in which no additive was added, respectively.

The additive amount of the stabilizer was 0.1 wt % in Table 1, 0.1 wt % or 0.4 wt % in Table 2 relative to the amount of the resin solution.

### Evaluation

After the viscosity of each Resin Solution II was measured by a viscometer (RE-115L available from Toki Sangyo Co., Ltd.), the Resin Solution II was entered in a 60 ° C. constant-temperature bath and was left for 1 month. The viscosity was measured by using the viscometer (RE-115L available from Toki Sangyo Co., Ltd.) at the 0^{th} day (i.e., immediately after the preparation of the Resin Solution II), the 14^{th} day, and the 30^{th} day from the start of leaving. The results are shown in Table 1.

As results after 1 month in the 60 ° C. bath, as shown in Table 1 and Table 2, the changing rate in viscosity of the Resin Solution I in which no additive and only VCVAC resin (C5R, VYHD) was added was from 10% to 25% (comparative examples), while the changing rate in viscosity of the Resin Solution II in which the additive and/or water were added was 5% or less (examples). It should be noted that the test solutions “a” through “f” in Table 2 correspond to the solutions shown a lower columns (6 test solutions of VYHD).

By adding the stabilizer (O-130P, #8102, #8105, #8832) into the VCVAC resin solution (C5R, VYHD) as shown in the above, it is possible to stably maintain the viscosity of the resin solution (resin solvent).

Using inkjet inks prepared by adding colorant into the resin solutions of the examples and comparative examples, changes of performance such as ejection stability, abrasion quality, drying property in an inkjet printer with age were checked.

As a result, in case of using any of the Resin Solutions I of the comparative examples, it was found that the viscosity was increased (the ink is thicken) so as to cause non-ejection and deflection of ink and the VCVAC resin was degraded with age so as to cause a decrease in performance such as abrasion quality and drying properties. However, in case of using any of the Resin Solutions II of the examples, printing was conducted without problem and none of the non-ejection and deflection of ink, and the decrease in performance such as abrasion quality and drying property was observed.

TABLE 1

| Resin | | | Leaving Period (day) | | |
|---|---|---|---|---|---|
| Solution | Additives | | 0^{th} day | 14^{th} day | 30^{th} day |
| C5R | None | Viscosity (mPa · s) | 7.02 | 8.40 | 8.61 |
| 5% | | Changing rate (%) | 0.0 | 11.7 | 22.6 |
| | Water | Viscosity (mPa · s) | 9.27 | 9.11 | 9.18 |
| | | Changing rate (%) | 0.0 | 1.7 | 1.0 |
| | #8102 | Viscosity (mPa · s) | 8.45 | 8.38 | 8.48 |
| | | Changing rate (%) | 0.0 | −0.8 | 0.4 |
| | O-130P | Viscosity (mPa · s) | 8.48 | 8.47 | 8.64 |
| | | Changing rate (%) | 0.0 | 0.0 | 1.9 |
| | #8102 + | Viscosity (mPa · s) | 9.24 | 9.23 | 9.38 |
| | water | Changing rate (%) | 0.0 | −0.1 | 1.5 |
| | O-130P + | Viscosity (mPa · s) | 9.24 | 9.12 | 9.18 |
| | water | Changing rate (%) | 0.0 | −1.3 | −0.6 |
| VYHD | None | Viscosity (mPa · s) | 7.40 | 8.02 | 8.19 |
| 5% | | Changing rate (%) | 0.0 | 8.4 | 10.8 |
| | Water | Viscosity (mPa · s) | 9.06 | 8.68 | 8.73 |
| | | Changing rate (%) | 0.0 | −4.2 | −3.6 |
| | #8102 | Viscosity (mPa · s) | 8.21 | 7.96 | 8.08 |
| | | Changing rate (%) | 0.0 | −3.0 | −1.5 |
| | O-130P | Viscosity (mPa · s) | 8.19 | 7.93 | 8.09 |
| | | Changing rate (%) | 0.0 | −3.2 | −1.3 |
| | #8102 + | Viscosity (mPa · s) | 9.06 | 8.75 | 8.71 |
| | water | Changing rate (%) | 0.0 | −3.4 | −3.8 |
| | O-130P + | Viscosity (mPa · s) | 8.91 | 8.56 | 8.58 |
| | water | Changing rate (%) | 0.0 | −4.0 | −3.7 |

In Table 2, Resin: VYHD 5%; Solvent: PMA, BMGAC, HeDG; and Stabilizer: #8105, #8832, O-130P.

### Viscosity Measurement

TABLE 2

| Additive amount [%] | | | | | | | | | |
|---|---|---|---|---|---|---|---|---|---|
| | #8102 | #8105 | #8832 | O130P | Water | | 0 | 14 | 30 |
| a | | | | | | Data | 7.40 | 8.02 | 8.19 |
| no additive | | | | | | (mPa · s) | | | |
| | | | | | | Changing | 0.0 | 8.4 | 10.7 |
| | | | | | | rate (%) | | | |
| b | | | | | 2* | Data | 9.06 | 8.68 | 8.73 |
| no additive + | | | | | | (mPa · s) | | | |
| water | | | | | | Changing | 0.0 | −4.2 | −3.6 |
| | | | | | | rate (%) | | | |
| c | 0.1 | | | | | Data | 8.21 | 7.96 | 8.08 |
| | | | | | | (mPa · s) | | | |
| | | | | | | Changing | 0.0 | −3.0 | −1.6 |
| | | | | | | rate (%) | | | |
| e | 0.1 | | | | 2* | Data | 9.06 | 8.75 | 8.71 |
| | | | | | | (mPa · s) | | | |
| | | | | | | Changing | 0.0 | −3.4 | −3.9 |
| | | | | | | rate (%) | | | |
| d | | | | 0.1 | | Data | 8.19 | 7.93 | 8.09 |
| | | | | | | (mPa · s) | | | |
| | | | | | | Changing | 0.0 | −3.2 | −1.2 |
| | | | | | | rate (%) | | | |
| f | | | | 0.1 | 2* | Data | 8.91 | 8.56 | 8.68 |
| | | | | | | (mPa · s) | | | |
| | | | | | | Changing | 0.0 | −3.9 | −2.6 |
| | | | | | | rate (%) | | | |
| 3 | | 0.1 | | | | Data | 8.42 | 7.69 | 7.74 |
| | | | | | | (mPa · s) | | | |
| | | | | | | Changing | 0.0 | −8.7 | −8.1 |
| | | | | | | rate (%) | | | |
| 9 | | 0.1 | | | 2* | Data | 7.91 | 7.51 | 7.66 |
| | | | | | | (mPa · s) | | | |
| | | | | | | Changing | 0.0 | −5.0 | −3.2 |
| | | | | | | rate (%) | | | |
| 4 | | 0.1 | | 0.4 | | Data | 8.58 | 8.04 | 8.12 |
| | | | | | | (mPa · s) | | | |
| | | | | | | Changing | 0.0 | −6.3 | −5.3 |
| | | | | | | rate (%) | | | |
| 10 | | 0.1 | | 0.4 | 2* | Data | 8.24 | 7.97 | 8.17 |
| | | | | | | (mPa · s) | | | |
| | | | | | | Changing | 0.0 | −3.3 | −0.9 |
| | | | | | | rate (%) | | | |
| 5 | | | 0.1 | | | Data | 8.62 | 8.04 | 8.17 |
| | | | | | | (mPa · s) | | | |
| | | | | | | Changing | 0.0 | −6.7 | −5.2 |
| | | | | | | rate (%) | | | |
| 11 | | | 0.1 | | 2* | Data | 7.86 | 7.46 | 7.52 |
| | | | | | | (mPa · s) | | | |
| | | | | | | Changing | 0.0 | −5.0 | −4.3 |
| | | | | | | rate (%) | | | |
| 6 | | | 0.1 | 0.4 | | Data | 8.34 | 7.84 | 7.94 |
| | | | | | | (mPa · s) | | | |
| | | | | | | Changing | 0.0 | −6.0 | −4.7 |
| | | | | | | rate (%) | | | |
| 12 | | | 0.1 | 0.4 | 2* | Data | 8.14 | 7.76 | 7.86 |
| | | | | | | (mPa · s) | | | |
| | | | | | | Changing | 0.0 | −4.6 | −3.4 |
| | | | | | | rate (%) | | | |

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. An inkjet ink containing a colorant and using vinyl chloride-vinyl acetate copolymer resin, wherein a stabilizer for preventing said vinyl chloride-vinyl acetate copolymer resin in the inkjet ink from being degraded with age is added.

2. The inkjet ink as claimed in claim 1, wherein said stabilizer is an organotin stabilizer.

3. The inkjet ink as claimed in claim 2, wherein said stabilizer is a combination of an organotin stabilizer and an epoxy-modified vegetable oil plasticizer.

4. The inkjet ink as claimed in claim 3, wherein said inkjet ink contains a solvent of one or a mixture of two of solvents represented by the following general formulas as a solvent for dissolving said vinyl chloride-vinyl acetate copolymer resin 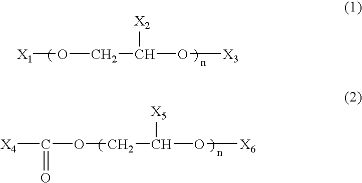
wherein in the above formulas (1), (2), each of X₁ through X₆ is H or an alkyl group.
